(19) United States
(12) Patent Application Publication
(10) Pub. No.: US 2010/0227761 A1
(43) Pub. Date: Sep. 9, 2010

(54) Agrochemical Formulations Based on Molecularly Imprinted Acrylates

(75) Inventors: Oliver Brüggemann, Frankfurt am Main (DE); Volker Braig, Weinheim-Lutzelsachsen (DE); Thomas Pfeiffer, Bohi-lggelheim (DE); Matthias Bratz, Maxdorf (DE); Aleksandra Volkmann, Berlin (DE)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/160,548

(22) PCT Filed: Jan. 5, 2007
(86) PCT No.: PCT/EP2007/050112

§ 371 Date: Jul. 10, 2008

(30) Foreign Application Priority Data
Jan. 12, 2006 (EP) 06100263.0

(51) Int. Cl. A01N 25/26; A01N 43/56; A01P 13/00; A01P 7/02; A01P 7/04; A01P 3/00

(52) U.S. Cl. 504/100; 514/407

(57) ABSTRACT

The present invention comprises the use of acrylate polymers molecularly imprinted in the presence of at least one pesticide for the preparation of an agrochemical formulation with controlled release of active agent, formulations comprising the abovementioned acrylate polymers molecularly imprinted in the presence of at least one pesticide and at least one pesticide, processes for the preparation of the abovementioned formulations and the use of the abovementioned formulations in plant protection.

The present invention comprises the use of acrylate polymers molecularly imprinted in the presence of at least one pesticide for the preparation of an agrochemical formulation with controlled release of active agent, formulations comprising the abovementioned acrylate polymers molecularly imprinted in the presence of at least one pesticide and at least one pesticide, processes for the preparation of the abovementioned formulations and the use of the abovementioned formulations in plant protection.

Environmental factors, such as wind, sun, rain and also groundwater, can bring about an undesirable dispersing of plant protection active agents. The amount of active agent can be so reduced by this that infestation by harmful organisms occurring later or later growth of undesirable plants may not be prevented.

Formulations with delayed release of active agent circumvent this problem by releasing fixed amounts of active agent in a delayed fashion over a certain period of time. It is also certainly desirable in some cases for the pests or weeds to be consulated by the direct release of a portion of the total amount of active agent used.

It was accordingly an object of the present invention to make available formulations in which a portion of the active agent is released directly and a further portion of the active agent is not released immediately but is released in a slowed down fashion over a relatively lengthy period of time.

The object was achieved by the use of acrylate polymers molecularly imprinted in the presence of a pesticide for the preparation of an agrochemical formulation with delayed release of active agent, the exact more specification of the formulation according to the invention being given further below.

Molecular imprinting of acrylate polymers with agrochemical active agents in the presence of difunctional crosslinking agents has hitherto been known only from the analytical field, e.g. J. Agric. Food Chem., 1995, 43, 1424-1427, Journal of Physics: Conference Series 10 (2005), 281-284, J. Agric. Food Chem., 1996, 44, 141-145, Chemistry Letters, 7 (1995), 491-612, but not for the preparation of agrochemical formulations.

The present invention accordingly comprises agrochemical formulation comprising acrylate polymers molecularly imprinted in the presence of at least one pesticide.

The abovementioned formulations can be prepared via a process, which comprises
(1) preparing the acrylate polymer by precipitation polymerization in the presence of the pesticide;
(2) subsequently washing the particles prepared with organic solvents; and
(3) incubating with a solution of the active agent, resulting in the particles becoming charged with active agent.

The molecularly imprinted acrylate polymers are synthesized from at least one functional monomer and at least one crosslinking agent.

The expression “acrylate polymer” describes polymers or copolymers which have been prepared at least on the basis of a monomer which has been chosen from the group consisting of acrylic acid, methacrylic acid and monomers derived from acrylic acid or methacrylic acid.

The expression “at least one functional monomer” means that one, two or several of the functional monomers can be used for the preparation of the acrylate molecularly imprinted in the presence of a pesticide, preferably one or two, particularly preferably one.

The expression “at least one crosslinking agent” means that one, two or several crosslinking agents can be used for the preparation of the acrylate molecularly imprinted in the presence of a pesticide, preferably one or two, particularly preferably one.

The expression “at least one pesticide” means that one, two or several pesticides can be used for the preparation of the molecularly imprinted acrylate, preferably one or two, particularly preferably one. The pesticide used here for the imprinting and the pesticide present in the formulation are either identical or structurally very similar, preferably identical.

The functional monomer can in this connection preferably be chosen from the group consisting of

hydroxyalkyl(meth)acrylates, such as, for example, 2-hydroxyethyl(meth)acrylate, 2-hydroxypropyl(meth)acrylate or 3-hydroxypropyl(meth)acrylate,

(meth)acrylamides, such as, for example, dimethyl(meth)acrylamide, diethyl-(meth)acrylamide, isopropyl(meth)acrylamide, (meth)acryloylmorpholine, dimethyl-aminomethyl(meth)acrylamide, dimethylaminoethyl(meth)acrylamide, dimethylamino-propyl(meth)acrylamide, diethylaminomethyl(meth)acrylamide, diethylaminoethyl-(meth)acrylamide or diethylaminopropyl(meth)acrylamide; and derivatives of (meth)acrylamide, such as, for example, N-methylacrylamide, N-methylolacrylamide or N-methylolmethacrylamide;

alkyl(meth)acrylates, such as, for example, methyl(meth)acrylate, ethyl (meth)acrylate, n-propyl(meth)acrylate, n-butyl(meth)acrylate, t-butyl(meth)acrylate, 2-ethylhexyl(meth)acrylate, stearyl(meth)acrylate, lauryl(meth)acrylate, cyclohexyl (meth)acrylate, stearyl(meth)acrylate, dodecyl(meth)acrylate, 2-hydroxyethyl (meth)acrylate or 2-hydroxypropyl(meth)acrylate,

cyano(alkyl)acrylates, such as, for example, cyanoalkyl(meth)acrylates (such as cyanoethyl(meth)acrylates or cyanopropyl(meth)acrylates);

acrylic acid and methacrylic acid, methacrylic acid being particularly preferred.

Furthermore, more than one functional monomer can be used. The choice may be made, as second or third functional monomer, of vinylbenzoic acid, vinylpyrrolidone, 4-vinylpyridine, 2-vinylpyridine, 1-vinylimidazole, 4(5)-vinylimidazole, itaconic acid, trifluoromethacrylic acid, 4-vinylbenzamidine, 4-vinylbenzyliminodiacetic acid and N-vinylamides, such as vinylformamide; 4-vinylpyridine, 2-vinylpyridine, 1-vinylimidazole, 4(5)-vinylimidazole, itaconic acid, trifluoromethacrylic acid, 4-vinylbenzamidine and 4-vinylbenzyliminodiacetic acid being preferred.

The crosslinking agent can here preferably be chosen from the group consisting of ethylenically unsaturated compounds with at least two (i.e., two, three or four) vinyl or allylic double bonds which can be polymerized under free radical conditions, thus, e.g., divinyl esters of aliphatic and aromatic dicarboxylic acids (e.g., the divinyl ester of succinic acid or the diallyl ester of phthalic acid), oligoallyl esters (such as, e.g., triallyl phosphate or triallyl isocyanurate), divinyl ethers of aliphatic and aromatic diols (e.g., 1,4-butanediol divinyl ether or diallyl bisphenol A), the reaction products of OH-terminated oligomeric polybutadienes with maleic acid or (meth)acrylic acid, i.e. oligomeric polybutadienes with activated photopolymerizable olefinic double bonds, di(meth)acrylates of alkylene glycols or alkanediols (such as, e.g., ethylene glycol dimethacrylate), divinylaromatic compounds (such as, e.g., divinylbenzene or diallylbenzene), bisacrylamides (such as, e.g., N,N′-methylenebisacrylamide, N,N′-phenylenebisacrylamide or 2,6-bisacrylamidopyridine), bisacryloylpiperazine, di- and triallyl ethers or di- and tri(meth)acrylates or triols (such as, e.g., of trimethylol-ethane, trimethylolpropane or triethanolamine), di-, tri- and tetraallyl ethers or di-, tri- and tetra(meth)acrylates of tetraols (such as, e.g., of pentaerythritol), oligo-(meth)acrylates of polyfunctional phenols with 2 to 4 OH groups (such as, e.g., of pyrocatechol, hydroquinone, bisphenol A or bisphenol F), and all additional oligo(meth)acrylates, oligoallyl monomers and oligovinyl monomers.

Use may also be made, as crosslinking agents, of alkoxylated di- or polyols which can then be correspondingly reacted with the functional monomer, for example ethoxytrimethylolpropane triacrylate.

Use is made particularly preferably of crosslinking agents of threefold or higher functionality, e.g. oligoallyl esters with three or more allyl groups, such as, e.g., triallyl phosphate or triallyl isocyanurate, triallyl ethers or tri(meth)acrylates of triols (such as, e.g., of trimethylolethane, trimethylolpropane or triethanolamine), tri- and tetraallyl ethers or tri- and tetra(meth)acrylates of tetraols (such as, e.g., of pentaerythritol), oligo(meth)acrylates of polyfunctional phenols with 3 to 4 OH groups (such as, e.g., pyrocatechol), and oligoacrylates, oligomethacrylates, oligoallyl monomers and oligovinyl monomers comprising at least three functional groups.

The molar ratio of functional monomer to crosslinking agent is generally 1/2 to 1/10, preferably 1/2 to 1/4.

All embodiments of the abovementioned acrylates molecularly imprinted with pesticide are described below as “MIA”.

In the MIAs, the ratio by weight of polymer to active agent is 1:10 to 100:1 (w/w), preferably 1:1 to 10:1 (w/w), particularly preferably 4:1 to 5:1 (w/w).

In this connection, the acrylate polymer is preferably synthesized from at least one of the abovementioned functional monomers and at least one of the abovementioned crosslinking agents.

The term “agrochemical active agent/pesticide” describes here at least one active agent chosen from the group consisting of the insecticides, fungicides, herbicides and/or safeners, and growth regulators (see Pesticide Manual, 13th Ed. (2003)). In this connection, combinations of two or several of the active agents mentioned below can also be used.

The following list of insecticides demonstrates possible active agents but should not be limited to these:

A.1. Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl parathion, mevinphos, monocrotophos, oxydemetonmethyl, paraoxon, parathion, phenthoate, phosalone, phosmet, phosphamidon, phorate, phoxim, pirimiphosmethyl, profenofos, prothiofos, sulprofos, tetrachlorvinphos, terbufos, triazophos, trichlorfon;

A.2. Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;

A.3. Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin and flucythrinate;

A.4. Growth regulators: a) chitin synthesis inhibitors: benzoylureas: chlorfluazuron, cyromazine, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenile hormone mimics: pyriproxyfen, methoprene, fenoxycarb; d) lipid biosynthesis inhibitors: spirodiclofen, spiromesifen;

A.5. Nicotine receptor agonists/antagonists: clothianidin, dinotefuran, imidacloprid, thiamethoxam, nitenpyram, acetamiprid, thiacloprid, a triazole compound of the formula Δ¹;

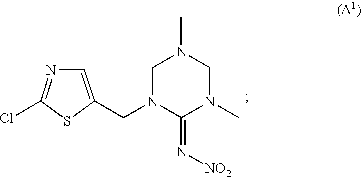

A.6. GABA antagonists: acetoprole, endosulfan, ethiprole, fipronil, vaniliprole, a phenylpyrazole compound of the formula Δ²;

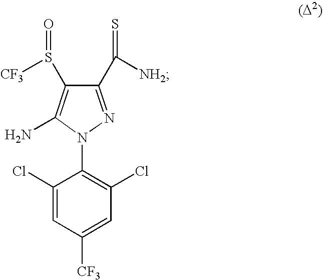

A.7. Macrolide insecticides: abamectin, emamectin, milbemectin, lepimectin, spinosad, a compound of the formula Δ³ (CAS No. 187166-40-1)

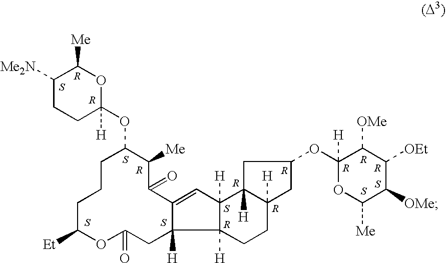

A.8. METI I acaricides: fenazaquin, pyridaben, tebufenpyrad, tolfenpyrad;

A.9. METI II and III compounds: acequinocyl, fluacyprim, hydramethylnon;

A.10. Uncoupling compounds: chlorfenapyr;

A.11. Inhibitors of oxidative phosphorylation: cyhexatin, diafenthiuron, fenbutatin oxide, propargite;

A.12. Molting disruptors: cyromazine;

A.13. Inhibitors of mixed-function oxidase: piperonyl butoxide;

A.14. Sodium channel blockers: indoxacarb, metaflumizone;

A.15. Various: benclothiaz, bifenazate, cartap, flonicamid, pyridalyl, pymetrozine, sulfur, thiocyclam, flubendiamide, cyenopyrafren, flupyrazofos, cyflumetofen, amidoflumet, compounds of the formula Δ⁴

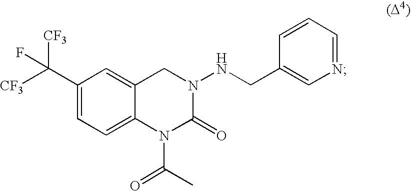

N—R′-2,2-Dihalo-1-R″-cyclopropanecarboxamide 2-(2,6-dichloro-α,α,α-trifluoro-p-tolyl)hydrazone or N—R′-2,2-di(R′″)-propionamide 2-(2,6-dichloro-α,α,α-trifluoro-p-tolyl)hydrazone, R′ being methyl or ethyl, halo being chlorine or bromine, R″ being hydrogen or methyl and R′″ being methyl or ethyl, anthranilamides of the formula Δ⁵

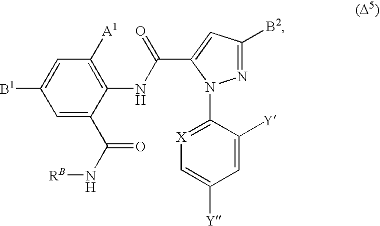

in which A¹ is CH₃, Cl, Br, I, X is C—H, C—Cl, C—F or N, Y′ is F, Cl or Br, Y″ is F, Cl or CF₃, B¹ is hydrogen, Cl, Br, I, CN, B² is Cl, Br, CF₃, OCH₂CF₃ or OCF₂H and R^{B} is hydrogen, CH₃ or CH(CH₃)₂, and malononitrile compounds, as described in JP 2002 284608, WO 02/89579, WO 02/90320, WO 02/90321, WO 04/06677, WO 04/20399 or JP 2004 99597.

The following list of fungicides demonstrates possible active agents but should not be limited to these:

1. Strobilurins

azoxystrobin, dimoxystrobin, enestroburin, fluoxastrobin, kresoxim-methyl, metominostrobin, picoxystrobin, pyraclostrobin, trifloxystrobin, orysastrobin, methyl (2-chloro-5-[1-(3-methylbenzyloxyimino)ethyl]benzyl)carbamate, methyl (2-chloro-5-[1-(6-methylpyrid-2-ylmethoxyimino)ethyl]benzyl)carbamate, methyl 2-(ortho-(2,5-dimethylphenyloxymethylene)phenyl)-3-methoxyacrylate;

2. Carboxamides
carboxanilides: benalaxyl, benodanil, boscalid, carboxin, mepronil, fenfuram, fenhexamide, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-(trifluoromethyl)biphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoro-methyl-1-methylpyrazole-4-carboxamide, N-(2-cyanophenyl)-3,4-dichloroisothiazole-5-carboxamide;
carboxylic acid morpholides: dimethomorph, flumorph;
benzamides: flumetover, fluopicolide (picobenzamid), zoxamide;
other carboxamides: carpropamid, diclocymet, mandipropamid, N-(2-(4-[3-(4-chloro-phenyl)prop-2-ynyloxy]-3-methoxyphenyl)ethyl)-2-methylsulfonylamino-3-methyl-butyramide, N-(2-(4-[3-(4-chlorophenyl)prop-2-ynyloxy]-3-methoxyphenyl)ethyl)-2-ethylsulfonylamino-3-methylbutyramide;

3. Azoles
triazoles: bitertanol, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticonazole;
imidazoles: cyazofamid, imazalil, pefurazoate, prochloraz, triflumizole;
benzimidazoles: benomyl, carbendazim, fuberidazole, thiabendazole;
others: ethaboxam, etridiazole, hymexazol;

4. Nitrogen-Comprising Heterocyclyl Compounds:
pyridines: fluazinam, pyrifenox, 3-[5-(4-chlorophenyl)-2,3-dimethylisoxazolidin-3-yl]-pyridine;
pyrimidines: bupirimate, cyprodinil, ferimzone, fenarimol, mepanipyrim, nuarimol,
pyrimethanil;
piperazines: triforine;
pyrroles: fludioxonil, fenpiclonil;
morpholines: aldimorph, dodemorph, fenpropimorph, tridemorph;
dicarboximides: iprodione, procymidone, vinclozolin;
others: acibenzolar-S-methyl, anilazine, captan, captafol, dazomet, diclomezine, fenoxanil, folpet, fenpropidin, famoxadone, fenamidone, octhilinone, probenazole, proquinazid, pyroquilon, quinoxyfen, tricyclazole, 5-chloro-7-(4-methylpiperid-1-yl)-6-(2,4,6-trifluorophenyl)-[1,2,4]triazolo[1,5-a]pyrimidine, 2-butoxy-6-iodo-3-propyl-chromen-4-one, N,N-dimethyl-3-(3-bromo-6-fluoro-2-methylindol-1-sulfonyl)-[1,2,4]triazole-1-sulfonamide;

5. Carbamates and Dithiocarbamates
dithiocarbamates: ferbam, mancozeb, maneb, metiram, metam, propineb, thiram, zineb, ziram;
carbamates: diethofencarb, flubenthiavalicarb, iprovalicarb, propamocarb, methyl 3-(4-chlorophenyl)-3-(2-isopropoxycarbonylamino-3-methylbutyrylamino)propionate, 4-fluorophenyl N-(1-(1-(4-cyanophenyl)ethylsulfonyl)but-2-yl)carbamate;

6. Other Fungicides
guanidines: dodine, iminoctadine, guazatine;
antibiotics: kasugamycin, polyoxins, streptomycin, validamycin A;
organometallic compounds: fentin salts;
sulfur-comprising heterocyclyl compounds: isoprothiolane, dithianon;
organophosphorus compounds: edifenphos, fosetyl, fosetyl-aluminum, iprobenfos, pyrazophos, tolclofos-methyl, phosphorous acid and its salts;
organochlorine compounds: thiophanate-methyl, chlorothalonil, dichlofluanid, tolylfluanid, flusulfamide, phthalide, hexachlorobenzene, pencycuron, quintozene;
nitrophenyl derivates: binapacryl, dinocap, dinobuton;
inorganic active agents: Bordeaux mixture, copper acetate, copper hydroxide, copper oxychloride, basic copper sulfate, sulfur;
others: spiroxamine, cyflufenamid, cymoxanil, metrafenone.

The following list of herbicides demonstrates possible active agents but should not be limited to these:

compounds which inhibit the biosynthesis of lipids, e.g. chlorazifop, clodinafop, clofop, cyhalofop, ciclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop, alloxydim, butroxydim, clethodim, cloproxydim, cycloxydim, profoxydim, sethoxydim, tepraloxydim, tralkoxydim, butylate, cycloate, di-allate, dimepiperate, EPTC, esprocarb, ethiolate, isopolinate, methiobencarb, molinate, orbencarb, pebulate, prosulfocarb, sulfallate, thiobencarb, thiocarbazil, tri-allate, vernolate, benfuresate, ethofumesate and bensulide;

ALS inhibitors, such as amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, suifosulfuron, thifensulfuron, triasulfuron, tribenuron, trifloxysulfuron, triflusulfuron, tritosulfuron, imazamethabenz, imazamox, imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid and pyrithiobac;

compounds which inhibit photosynthesis, such as atraton, atrazine, ametryn, aziprotryn, cyanazine, cyanatryn, chlorazine, cyprazine, desmetryn, dimethametryn, dipropetryn, eglinazine, ipazine, mesoprazine, methometon, methoprotryne, procyazine, proglinazine, prometon, prometryn, propazine, sebuthylazine, secbumeton, simazine, simeton, simetryn, terbumeton, terbuthylazine and terbutryn;

protoporphyrinogen IX oxidase inhibitors, such as acifluorfen, bifenox, chlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen and etnipromid;

herbicides, such as metflurazon, norflurazon, flufenican, diflufenican, picolinafen, beflubutamid, fluridone, fluorochloridone, flurtamone, mesotrione, sulcotrione, isoxachlortole, isoxaflutole, benzofenap, pyrazolynate, pyrazoxyfen, benzobicyclon, amitrole, clomazone, aclonifen, 4-(3-trifluoromethylphenoxy)-2-(4-trifluoro-methylphenyl)pyrimidine and 3-heterocyclyl-substituted benzoyl derivatives of the formula (cf. WO-A-96/26202, WO-A-97/41116, WO-A-97/41117 and WO-A-97/41118)

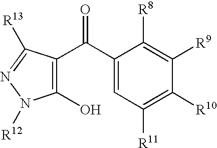

in which the substituents R⁸ to R¹³ have the following meanings:
R⁸, R¹⁰ represent hydrogen, halogen, C₁-C₆-alkyl, C₁-C₆-haloalkyl, C₁-C₆-alkoxy, C₁-C₆-haloalkoxy, C₁-C₆-alkylthio, C₁-C₆-alkylsulfinyl or C₁-C₆-alkylsulfonyl;
R⁹ represents a heterocyclic radical from the group consisting of thiazol-2-yl, thiazol-4-yl, thiazol-5-yl, isoxazol-3-yl, isoxazol-4-yl, isoxazol-5-yl, 4,5-dihydroisoxazol-3-yl, 4,5-dihydroisoxazol-4-yl and 4,5-dihydroisoxazol-5-yl, in which the abovementioned radicals can carry one or more substituents, e.g. can be mono-, di-, tri- or tetrasubstituted by halogen, C₁-C₄-alkyl, C₁-C₄-alkoxy, C₁-C₄-haloalkyl, C₁-C₄-haloalkoxy or C₁-C₄-alkylthio;
R¹¹ represents hydrogen, halogen or C₁-C₆-alkyl;
R¹² represents C₁-C₆-alkyl;
R¹³ represents hydrogen or C₁-C₆-alkyl.

Additional suitable herbicides are EPSP synthase inhibitors, such as glyphosate;

glutamine synthase inhibitors, such as glufosinate and bilanafos;

DHP synthase inhibitors, such as asulam;

mitosis inhibitors, such as benfluralin, butralin, dinitramine, ethaifluralin, fluchloralin, isopropalin, methalpropalin, nitralin, oryzalin, pendimethalin, prodiamine, profluralin, trifluralin, amiprofos-methyl, butamifos, dithiopyr, thiazopyr, propyzamide, tebutam, chlorthal, carbetamide, chlorbufam, chlorpropham and propham;

VLCFA inhibitors, such as acetochlor, alachlor, butachlor, butenachlor, delachlor, diethatyl, dimethachlor, dimethenamid, dimethenamid-P, metazachlor, metolachlor, S-metolachlor, pretilachlor, propachlor, propisochior, prynachlor, terbuchlor, thenylchlor, xylachlor, allidochlor, CDEA, epronaz, diphenamid, napropamide, naproanilide, pethoxam id, flufenacet, mefenacet, fentrazamide, anilofos, piperophos, cafenstrole, indanofan and tridiphane;

inhibitors for the biosynthesis of cellulose, such as dichlobenil, chiorthiamid, isoxaben and flupoxam;

herbicides, such as dinofenate, dinoprop, dinosam, dinoseb, dinoterb, DNOC, etinofen and medinoterb;

auxin herbicides, such as clomeprop, 2,4-D, 2,4,5-T, MCPA, MCPA-thioethyl, dichlorprop, dichlorprop-P, mecoprop, mecoprop-P, 2,4-DB, MCPB, chioramben, dicamba, 2,3,6-TBA, tricamba, quinclorac, quinmerac, clopyralid, fluoroxypyr, picloram, triclopyr and benazolin;

auxin transport inhibitors, such as naptalam, diflufenzopyr;

in addition: benzoylprop, flamprop, flamprop-M, bromobutide, chlorflurenol, cinmethylin, methyldymron, etobenzanid, fosamine, metam, pyributicarb, oxaziclomefone, dazomet, triaziflam and methyl bromide.

The term “safener” has the following meaning: it is known that, in some cases, better herbicidal tolerance can be achieved by the joint application of herbicides having a specific action with organic active compounds which themselves can exert a herbicidal effect. In these cases, these compounds act as antidote or antagonist and, because they reduce or avert damage to useful plants, are described as “safeners”.

The following list demonstrates possible safeners but should not be limited to these:

benoxacor, cloquintocet, cyometrinil, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloroacetyl)-1,3-oxazolidine (R-29148), 4-(dichloroacetyl)-1-oxa-4-azaspiro[4.5]decane (AD-67; MON 4660) and oxabetrinil.

The following list of compounds with a growth-regulating effect demonstrates possible active agents but should not be limited to these:

1-naphthaleneacetamide, 1-naphthaleneacetic acid, 2-naphthoxyacetic acid, 3-CPA, 4-CPA, ancymidol, anthraquinone, BAP, butifos, tribufos, butralin, chlorflurenol, chlormequat, clofencet, cyclanilide, daminozide, dicamba, dikegulac-sodium, dimethipin, chlorfenethol, etacelasil, ethephon, ethychlozate, fenoprop, 2,4,5-TP, fluoridamid, flurprimidol, flutriafol, gibberellic acid, gibberellin, guazatine, imazalil, indolebutyric acid, indoleacetic acid, karetazan, kinetin, lactidichlor-ethyl, maleic hydrazide, mefluidide, mepiquat chloride, naptalam, paclobutrazol, prohexadione-calcium, quinmerac, sintofen, tetcyclacis, thidiazuron, triiodobenzoic acid, triapenthenol, triazethan, tribufos, trinexapac-ethyl, uniconazole.

Preferred insecticides are metaflumizone, pyrethroids, such as allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, flucythrinate, preferably alpha-cypermethrin, cypermethrin, permethrin and flucythrinate, and also GABA antagonists (e.g., acetoprole, endosulfan, ethiprole, fipronil, vaniliprole), fipronil being especially preferred.

Preferred fungicides are azole fungicides, such as triazole fungicides, such as bitertanol, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticonazole; imidazole fungicides, such as cyazofamid, imazalil, pefurazoate, prochloraz, triflumizole; benzimidazole fungicides, such as benomyl, carbendazim, fuberidazole, thiabendazole; and also other azole fungicides, such as ethaboxam, etridiazole, hymexazol; and strobilurin fungicides, such as azoxystrobin, dimoxystrobin, enestroburin, fluoxastrobin, kresoxim-methyl, metominostrobin, picoxystrobin, pyraclostrobin, trifloxystrobin, orysastrobin, methyl (2-chloro-5-[1-(3-methylbenzyloxy-imino)ethyl]benzyl)carbamate, methyl (2-chloro-5-[1-(6-methylpyrid-2-ylmethoxyimino)-ethyl]benzyl)carbamate, methyl 2-(ortho-(2,5-dimethylphenyloxymethylene)phenyl)-3-methoxyacrylate; triazole fungicides, such as bitertanol, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticonazole; imidazole fungicides, such as cyazofamid, imazalil, pefurazoate, prochloraz, triflumizole; and also the abovementioned strobilurin fungicides being particularly preferered, and epoxiconazole, fluquinconazole, triticonazole, prochloraz, kresoxim-methyl, pyraclostrobin and orysastrobin being very particualrly preferred.

The abovementioned process for the preparation of the molecularly imprinted acrylate polymers according to the invention is, as aleady explained, that which comprises
(1) preparing the acrylate polymer by precipitation polymerization in the presence of the pesticide;
(2) subsequently washing the particles prepared with organic solvents; and
(3) incubating with a solution of the active agent, resulting in the particles becoming charged with active agent.

A person skilled in the art is familiar with the basic principle, necessary for stage (1) of the process, of precipitation polymerization, which is described, for example, in Guyot, A. (1989), in: Comprehensive Polymer Science, Vol. 4: Eastmond, G. C., Ledwith, A., Russo, S., Sigwalt, P. (Eds.). Oxford: Pergamon, pp. 261-273.

In a preferred embodiment, the molecularly imprinted acrylate polymer according to the invention can be prepared by
(a) mixing at least one functional monomer with at least one pesticide in a suitable solvent, adding at least one crosslinking agent and starting the polymerization; the crosslinking agent preferably being dissolved beforehand in a solvent which corresponds, in a very particularly preferred embodiment, to the solvent in which the monomer is dissolved, or
(b) mixing at least one functional monomer with at least one pesticide and at least one crosslinking agent in a suitable solvent and subsequently starting the polymerization.

A protective colloid can also optionally be used in stage a). Surface-active agents are suitable as protective colloids. The term “surface-active agent” is defined further below.

The polymerization can be carried out according to a radical, anionic, cationic or coordination mechanism or according to the principle of a polycondensation or polyaddition. Polymerization is preferably carried out via a radical mechanism. In this connection, various initiators and/or catalysts can be used, if appropriate also in combination with the introduction of heat.

For cationic polymerizations, use may be made, for example, of the following initiators:

protic acids, Lewis acids, with and without coinitiators, carbonium ions, iodonium ions and/or ionizing radiation.

For anionic polymerizations, use may be made of the following initiators: bases, Lewis bases, organometallic compounds and/or electron carriers, e.g. alkali metals, alkali metal/aromatics complexes or metal ketyls.

For coordination polymerizations, use may be made of the following initiators/catalysts:

organometallic mixed catalysts (Ziegler-Natta catalysts), 7-complexes with transition metals, e.g. metallocenes, and/or activated transition metal oxides.

For the radical polymerization, suitable initiators are, for example, peroxides or azo compounds, substituted ethanes (e.g. benzopinacols), redox systems with inorganic and organic components, heat, UV light and other high-energy radiation, hydroperoxides, peresters and persulfates, such as, e.g., potassium peroxodisulfate, preferably azo compounds.

Suitable azo compounds are 2,2′-azobisisobutyronitrile, 2,2′-azobis(2-methyl-butyronitrile), 2,2′-azobis(2,4-dimethylvaleronitrile), 2,2′-azobis(4-methoxy-2,4-dimethyl-valeronitrile), 1,1′-azobis(1-cyclohexanecarbonitrile), 2,2′-azobis(isobutyramide) dihydrate, 2-phenylazo-2,4-dimethyl-4-methoxyvaleronitrile, dimethyl 2,2′-azobis-isobutyrate, 2-(carbamoylazo)isobutyronitrile, 2,2′-azobis(2,4,4-trimethylpentane), 2,2′-azobis(2-methylpropane), 2,2′-azobis(N,N′-dimethyleneisobutyramidine), as free base or as hydrochloride, 2,2′-azobis(2-amidinopropane), as free base or as hydrochloride, 2,2′-azobis(2-methyl-N-[1,1-bis(hydroxymethyl)ethyl]propionamide) or 2,2′-azobis(2-methyl-N-[1,1-bis(hydroxymethyl)-2-hydroxyethyl]propionamide).

Suitable peroxides are, for example, acetylcyclohexanesulfonyl peroxide, diisopropyl peroxydicarbonate, t-amyl perneodecanoate, t-butyl perneodecanoate, t-butyl perpivalate, t-amyl perpivalate, bis(2,4-dichlorobenzoyl) peroxide, diisononanoyl peroxide, didecanoyl peroxide, dioctanoyl peroxide, dilauroyl peroxide, bis(2-methyl-benzoyl) peroxide, disuccinoyl peroxide, diacetyl peroxide, dibenzoyl peroxide, t-butyl per-2-ethyl hexanoate, bis(4-chlorobenzoyl) peroxide, t-butyl perisobutyrate, t-butyl permaleate, 1,1-bis(t-butylperoxy)-3,5,5-trimethylcyclohexane, 1,1-bis(t-butylperoxy)-cyclohexane, t-butylperoxy isopropyl carbonate, t-butyl perisononanoate, t-butyl peracetate, t-amyl perbenzoate, t-butyl perbenzoate, 2,2-bis(t-butylperoxy)butane, 2,2-bis-10-(t-butylperoxy)propane, dicumyl peroxide, 2,5-dimethyl-2,5-bis(t-butylperoxy)hexane, 3-(t-butylperoxy)-3-phenylphthalide, di(t-amyl) peroxide, α,α′-bis(t-butylperoxyisopropyl)benzene, 3,5-bis(t-butylperoxy)-3,5-dimethyl-1,2-dioxolane, di(t-butyl) peroxide, 2,5-dimethyl-2,5-bis(t-butylperoxy)hexyne, 3,3,6,6,9,9-hexamethyl-1,2,4,5-tetraoxacyclononane, p-menthane hydroperoxide, pinane hydroperoxide, diisopropylbenzene, mono-α-hydroperoxide, cumene hydroperoxide or t-butyl hydroperoxide.

Suitable initiators are furthermore redox systems, such as, e.g., Fe/H₂O₂, ascorbic acid/H₂O₂, the are sulfinic acid derivatives, such as from Brüggemann, e.g. disodium 2-dihydroxy-2-sulfinatoacetate (e.g., Brüggolite from Brüggemann), and also H₂O₂.

Mixtures of different initiators can also be used.

The crosslinking agent can, depending on the physical state, be added to the reaction mixture in solid or liquid form or can be added dissolved or dispersed (i.e., emulsified or suspended) in a solvent, preferably dissolved. Preferably, a liquid crosslinking agent or a crosslinking agent dissolved (or dispersed/mixed) in a solvent is added to the reaction mixture, particularly preferably a crosslinking agent dissolved (or dispersed/mixed) in a solvent. In a very particularly preferred embodiment, the crosslinking agent is dissolved in the same solvent as the functional monomer or the pesticide.

Use may be made, as solvent, of all solvents in which the monomers necessary for the preparation of the particles prepared in stage (1) are soluble. Thus, e.g., use may be made of organic solvents, such as dimethylformamide, ethanol, methanol, isopropanol, chloroform, dichloromethane, toluene, dimethyl sulfoxide, hexane and acetonitrile, preferably toluene and acetonitrile.

Mixtures of the abovementioned solvents can also be used.

In an additional embodiment, water can be added to the solvent or the solvent mixtures up to a proportion of 50% (w/w).

Generally, polymerization is carried out in the temperature range of 40-120° C., depending on the solvent used.

The washing process with organic solvents described in stage (2) can be carried out according to methods known to a person skilled in the art (e.g., as Soxhlet extraction, or by redispersing the particles obtained from stage (1) in organic solvents with subsequent removal, e.g. via filtration methods or via filtration techniques in which the residue remaining in the filter is washed with solvent).

Use may be made, as organic solvent, of any organic solvent in which the monomers of the particles prepared in stage (1) are soluble. For example, use is made of organic solvents, such as dimethylformamide, ethanol, methanol, isopropanol, chloroform, dichloromethane, toluene, dimethyl sulfoxide, hexane and acetonitrile, preferably toluene and acetonitrile. Mixtures of the abovementioned solvents can also be used. In an additional embodiment, acetic acid or water or mixtures of acetic acid and water can be added to the solvent or the solvent mixtures up to a proportion of 50% (w/w).

After the washing stage carried out in stage (2), the particles can optionally be dried (e.g., at temperatures of 10-130° C., preferably at temperatures of 20-100° C.).

Charging with active agent is carried out in stage (3). In this stage, the particles prepared in stage (1) and washed in stage (2) are incubated with an active agent solution. The incubation time depends on polymer and active agent. For example, incubation can be carried out for 30 min to 24 h at temperatures of 5° C. to 30° C.

The active agent can in this connection be dissolved in an organic solvent or a mixture of organic solvents or water. The choice of the solvent depends on the nature of the active agent. It is important in this connection for the active agent to be completely dissolved, i.e. molecularly dispersed.

Subsequently, the active agent solution is removed via methods standard for a person skilled in the art (e.g., filtration).

The active agent solution can come to different concentrations, depending on an active agent. Thus, active agent solutions can be used from molar concentrations of active agent of 0.01 up to saturated solutions.

All embodiments of the abovementioned particle are described subsequently as “MIA”.

The particles precipitated during the polymerization can either be used directly or can be treated with formulation auxiliaries and appropriately formulated.

Examples of formulation types which can be prepared based on the MIA are in this instance suspensions (SC, OD, FS), pastes, pellets, wettable powders, dusts (WP, SP, SS, WS, DP, DS) or granules (GR, FG, GG, MG), which can be either soluble or dispersible (wettable) in water, and gel formulations for seed treatment (GF). The preparation of these formulations and the technology necessary therefor are known to a person skilled in the art since the MIA-comprising preparations can be used analogously like agrochemical active agents or carriers charged with active agent (cf. U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pp. 8-57 and ff., WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2 095 558, U.S. Pat. No. 3,299,566, Klingman, Weed Control as a Science, John Wiley and Sons Inc., New York, 1961, Hance et al., Weed Control Handbook, 8th Ed., Blackwell Scientific Publications, Oxford, 1989 and Mollet, H., Grubemann, A., Formulation Technology, Wiley VCH Verlag GmbH, Weinheim (Federal Republic of Germany), 2001).

Thus, the abovementioned formulations can be prepared, e.g., by extending the MIA with solvents and/or carriers, if desired with the use of auxiliaries.

The term “auxiliaries” describes surface-active agents (such as wetting agents, deposit builders or dispersants, protective colloids or adjuvants), antifoaming agents, thickeners, antifreeze agents, bactericides and, if seed dressing formulations are concerned, if appropriate adhesives and/or, if appropriate, colorants.

Suitable solvents are, e.g., water, aromatic solvents (e.g., Solvesso products, xylene), paraffins (e.g., petroleum fractions), alcohols (e.g., methanol, butanol, pentanol, benzyl alcohol), ketones (e.g., cyclohexanone, γ-butyrolactone), pyrrolidones (NMP, NOP), acetates (glycol diacetate), glycols, dimethyl amides of fatty acids, fatty acids and fatty acid esters. In principle, solvent mixtures can also be used.

Suitable carriers are, e.g., ground natural minerals (e.g., kaolins, argillaceous earths, talc, chalk, bole, loess, clay, dolomite, diatomaceous earth) and ground synthetic minerals (e.g., highly dispersed silica, silicates, calcium and magnesium sulfate, magnesium oxide), ground plastics, fertilizers, such as, e.g., ammonium sulfate, ammonium phosphate, ammonium nitrate, ureas, and plant products, such as cereal meal, tree bark meal, wood meal and nutshell meal, cellulose powders and other solid carriers.

Use is made, as surface-active agents, of alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers; also suitable are condensation products of sulfonated naphthalene and naphthalene derivatives with formaldehyde, condensation products of naphthalene or of naphthalenesulfonic acid with phenol and formaldehyde, polyoxyethylene octylphenol ethers, ethoxylated isooctylphenol, octylphenol and nonylphenol, alkylphenol polyglycol ethers, tributyl-phenyl polyglycol ethers, tristearylphenyl polyglycol ethers, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

All protective colloids standard for the formulation of agrochemical active agents are suitable as protective colloids, i.e., in the present case, all water-soluble polymers with an amphiphilic nature known to a person skilled in the art, such as, for example, proteins, denatured proteins, polysaccharides, hydrophobically modified starches and synthetic polymers.

All thickeners standard for the formulation of agrochemical active agents are suitable as thickeners which may be present in the formulations according to the invention. Examples of thickeners (i.e., compounds which bestow a pseudoplastic flow behavior on the formulation, i.e. high viscosity at rest and low viscosity in the agitated state) are, for example, polysaccharides or organic and inorganic layered minerals, such as xanthan gum (Kelzan® from Kelco), Rhodopol® 23 (Rhône-Poulenc) or Veegum® (R.T. Vanderbilt) or Attaclay® (Engelhardt).

All antifoaming agents standard for the formulation of agrochemical active agents are suitable as antifoaming agents which may be present in the formulations according to the invention. Examples of antifoaming agents are silicone emulsions (such as, e.g., Silikon® SRE, Wacker or Rhodorsil® from Rhodia), long-chain alcohols, fatty acids, fluoroorganic compounds and the mixtures thereof.

Bactericides can be added to stabilize aqueous formulation types. All bactericides standard for the formulation of agrochemical active agents are suitable as bactericides which may be present in the formulations according to the invention, such as, for example, bactericides based on dichlorophen and benzyl alcohol hemiformal. Examples of bactericides are Proxel® from ICI or Acticide® RS from Thor Chemie and Kathon® MK from Rohm & Haas.

All antifreeze agents standard for the formulation of agrochemical active agents are suitable as antifreeze agents which may be present in the formulations according to the invention. Suitable antifreeze agents are, e.g., ethylene glycol, propylene glycol or glycerol, preferably propylene glycol and glycerol.

All colorants standard for such purposes are suitable as colorants. In this connection, use may be made of both pigments which are sparingly soluble in water and dyes which are soluble in water. Mention may be made, as examples, of the dyes known under the descriptions rhodamine B, C.I. Pigment Red 112 and C.I. Solvent Red 1, and also pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

All standard binders which can be used in seed dressings are possible as adhesives which may be present in the formulations according to the invention. Mention may preferably be made of polyvinylpyrrolidone, poly(vinyl acetate), poly(vinyl alcohol) and Tylose.

The significance and corresponding application of the abovementioned agents depend on the nature of the active agent.

Petroleum fractions having medium to high boiling points, such as kerosene or diesel fuel, furthermore coal tar oils, and oils of vegetable or animal origin, aliphatic, cyclic and aromatic hydrocarbons, e.g. toluene, xylene, paraffin, tetrahydronaphthalene, alkylated naphthalenes or the derivatives thereof, methanol, ethanol, propanol, butanol, cyclohexanol, cyclohexanone, isophorone, highly polar solvents, e.g. dimethyl sulfoxide, N-methylpyrrolidone or water, are suitable for the preparation of directly sprayable solutions, emulsions, pastes or oil dispersions.

The MIA can, for the preparation of suspension concentrates or gel formulations, be ground to a fine active agent suspension with addition of dispersants and wetting agents and water or an organic solvent (or solvent/water mixtures). With gel formulations, a gelling agent is yet added (e.g., carrageen (Satiagel®)). A stable suspension of the MIA is formed on diluting in water.

Powders, preparations for broadcasting and dusts can be prepared by mixing or mutually grinding the active substances with a solid carrier.

Granules, e.g. coated granules, impregnated granules and homogeneous granules, can be prepared by binding the MIA to solid carriers.

The formulations generally comprise between 0.01 and 95% by weight, preferably between 0.1 and 90% by weight, of the pesticide.

Formulation types (e.g., SC, OD, FS, WG, SG, WP, SP, SS, WS, GF) are generally used diluted. Formulation types such as DP, DS, GR, FG, GG, MG are generally used undiluted.

The formulation types (e.g., SC, OD, FS, WG, SG, WP, SP, SS, WS, GF, DP, DS) suitable for the seed treatment can, according to requirements, be used diluted or undiluted. In this connection, the corresponding formulation can be diluted 2- to 10-fold, so that 0.01 to 60% by weight, preferably 0.1 to 40% by weight, of the pesticide is available in the formulations to be used for the dressing.

The MIAs and all formulations which are prepared based on the MIAs are described below as MIA formulations.

The present invention claims a method for combating phytopathogenic fungi and/or undesirable plant growth and/or undesirable insect or acarid infestation and/or for regulating the growth of plants, wherein an MIA formulation is allowed to act on the respective pests (i.e., phytopathogenic fungi and/or undesirable insects or acarids), their habitat or the plants or soil to be protected from the respective pest and/or on undesirable plants and/or the useful plants and/or their habitat.

The present invention also claims a method for combating undesirable insect or acarid infestation on plants and/or for combating phytopathogenic fungi and/or for combating undesirable plant growth, wherein seeds of useful plants are treated with an MIA formulation suitable for the seed treatment.

In the context of the present invention, seed is also treated with an MIA formulation suitable for the seed treatment.

In this connection, the amounts of pesticide are 0.1 g to 10 kg per 100 kg of seed, preferably 1 g to 5 kg per 100 kg of seed, particularly preferably 1 g to 2.5 kg per 100 kg of seed. However, for special seed varieties, such as, e.g., lettuce seed, the amounts can be even higher.

The term “seed” comprises seed of all kinds, such as, e.g., grains, seeds, fruit, tubers, cuttings and similar forms. In this connection, the term “seed” preferably describes grains and seeds.

Suitable as seed are cereal seeds, grain crop seeds, root crop seeds, oleaginous seeds, vegetable seeds, spice seeds or ornamental plant seeds, e.g. seed of wheat, including hard wheat, barley, oats, rye, corn (fodder corn and sweet corn), soybean, oleaginous plants, crucifers, cotton, sunflowers, bananas, rice, rape, turnips, sugar beet, fodder beet, eggplants, potatoes, grass, lawns, fodder grass, tomatoes, leek, pumpkin, cabbage, iceberg lettuce, pepper, cucumbers, melons, Brassica spp., beans, peas, garlic, onions, carrots, tuberous plants, such as sugar cane, tobacco, grapes, petunias and geraniums, pansies, touch-me-not, preferably wheat, corn, soybean and rice.

The seed of transgenic plants or of plants obtained by conventional breeding methods can also be used as seed.

Thus, use may be made of seed which is tolerant to herbicides, fungicides or insecticides, e.g. to sulfonylureas, imidazolinones or glufosinate or glyphosates (see, e.g., EP-A-0 242 236, EP-A-242 246) (WO 92/00377) (EP-A-0 257 993, U.S. Pat. No. 5,013,659), or seed of transgenic plants, e.g. cotton, which produce Bacillus thuringiensis toxin (Bt toxins) and are thereby resistant to certain harmful organisms (EP-A-0 142 924, EP-A-0 193 259).

In addition, use may also be made of seed of plants which exhibit modified properties in comparison with conventional plants. Examples of this are modified starch synthesis (e.g., WO 92/11376, WO 92/14827, WO 91/19806) or fatty acid compositions (WO 91/13972).

The term “phytopathogenic fungi” describes but is not limited to the following species: Alternaria spp. on rice, vegetables, soybeans, rape, sugar beet and fruit, Aphanomyces spp. on sugar beet and vegetables, Bipolaris and Drechslera spp. on corn, cereals, rice and lawns, Blumeria graminis (powdery mildew) on cereals, Botrytis cinerea (gray mold) on strawberries, vegetables, ornamental flowers and grapes, Bremia lactucae on lettuce, Cercospora spp. on corn, soybean and sugar beet, Cochliobolus spp. on corn, cereals and rice (e.g. Cochfibbolus sativus on cereals, Cochliobolus miyabeanus on rice), Colletotfichum spp. on soybean and cotton, Drechslera spp. on cereals and corn, Exserohilum spp. on corn, Erysiphe cichoracearum and Sphaerotheca fuliginea on cucumbers, Erysiphe necatoron grapes, Fusarium and Verticillium spp. on various plants, Gaeumannomyces graminis on cereals, Gibberella spp. on cereals and rice (e.g. Gibberella fujikuroi on rice, Gibberella zeae on cereals), Grainstaining complex on rice, Microdochium nivale on cereals, Mycosphaerella spp. on cereals, bananas and peanuts, Phakopsora pachyrhizi and Phakopsora meibomiae on soybeans, Phomopsis spp. on soybean and sunflowers, Phytophthora infestans on potatoes and tomatoes, Plasmopara viticola on grapes, Podosphaera leucotricha on apples, Pseudocercosporella herpotrichoides on wheat and barley, Pseudoperonospora spp. on hops and cucumber, Puccinia spp. on cereals and corn, Pyrenophora spp. on cereals, Pyriculana oryzae on rice, Cochliobolus miyabeanus and Corticium sasakii (Rhizoctonia solani), Fusarium semitectum (and/or moniliforme), Cercospora oryzae, Sarocladium oryzae, S attenuatum, Entyloma oryzae, Gibberella fujikuroi (bakanae), Grainstaining complex (various pathogens), Bipolans spp., Drechslera spp. and Pythium and Rhizoctonia spp. on rice, corn, cotton, sunflower, rape (canola, oilseed rape), vegetables, lawns, nuts and other plants, Rhizoctonia solani on potato, Sclerotinia spp. on types of rape (canola/oilseed rape) and sunflower, Septoria tritici and Stagonospora nodorum on wheat, Uncinula necatoron grapes, Sphacelotheca reiliana on corn, Thievaliopsis spp. on soybean and cotton, Tilletia spp. on cereals, Ustilago spp. on cereals, corn and sugar cane and Venturia spp. (scab) on apples and pears.

The term “undesirable insect or acarid” describes but is not limited to the following types:

Millipedes (Diplopoda), e.g. Blaniulus spp.,

Ants (Hymenoptera), e.g. Atta capiguara, Atta cephalotes, Atta laevigata, Atta robusta, Atta sexdens, Atta texana, Monomorium pharaonis, Solenopsis geminata, Solenopsis invicta, Pogonomyrmex spp. and Pheidole megacephala,

Beetles (Coleoptera), e.g. Agrilus sinuatus, Agriotes lineatus, Agriotes obscurus and other Agriotes spp., Amphimallus solstitialis, Anisandrus dispar, Anthonomus grandis, Anthonomus pomorum, Aracanthus morei; Atomaria linearis, Blapstinus spp., Blastophagus piniperda, Blitophaga undata, Bothynoderes punciventris, Bruchus rufimanus, Bruchus pisorum, Bruchus lentis, Byctiscus betulae, Cassida nebulosa, Cerotoma trifurcate, Ceuthorrhynchus assimilis, Ceuthorrhynchus nap, Chaetocnema tibialis, Conoderus vespertinus and other Conoderus spp., Conorhynchus mendicus, Crioceris asparagi, Cylindrocopturus adspersus, Diabrotica (longicornis) barberi, Diabrotica semi-punctata, Diabrotica speciosa, Diabrotica undecimpunctata, Diabrotica virgifera and other Diabrotica spp., Eleodes spp., Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus and other Limonius spp., Lissorhoptrus oryzophilus, Listronotus bonariensis, Melanotus communis and other Melanotus spp., Meligethes aeneus, Melolontha hippocastani, Melolontha melolontha, Oulema oryzae, Ortiorrhynchus sulcatus, Oryzophagus oryzae, Otiorrhynchus ovatus, Oulema oryzae, Phaedon cochleariae, Phyllotreta chrysocephala, Phyllophaga cuyabana and other Phyllophaga spp., Phyllopertha horticola, Phyllotreta nemorum, Phyllotreta striolata, and other Phyllotreta spp., Popillia japonica, Promecops carinicollis, Premnotrypes voraz, Psylliodes spp., Sitona lineatus, Sitophilus granaria, Sternechus pinguis, Sternechus subsignatus, and Tanymechus palliatus and other Tanymechus spp.,

Flies (Diptera), e.g. Agromyza oryzea, Chrysomya bezziana, Chrysomya hominivorax, Chrysomya macellaria, Contarinia sorghicola, Cordylobia anthropophaga, Dacus cucurbitae, Dacus oleae, Dasineura brassicae, Delia antique, Delia coarctata, Delia platura, Delia radicum, Fannia canicularis, Gasterophilus intestinalis, Geomyza tripunctata, Glossina morsitans, Haematobia irritans, Haplodiplosis equestris, Hypoderma lineata, Liriomyza sativae, Liriomyza trifolii, Lucilia caprin, Lucilia cuprina, Lucilia sericata, Lycoria pectoralis, Mayetiola destructor, Muscina stabulans, Oestrus ovis, Opomyza florum, Oscinella frit, Pegomya hysocyami, Phorbia antiqua, Phorbia brassicae, Phorbia coarctata, Progonya leyoscianii, Psila rosae, Rhagoletis cerasi, Rhagoletis pomonella, Tabanus bovinus, Tetanops myopaeformis, Tipula oleracea and Tipula paludosa,

Heteroptera (Heteroptera), e.g. Acrosternum hilare, Blissus leucopterus, Cicadellidae, e.g. Empoasca fabae, Chrysomelidae, Cyrtopeltis notatus, Delphacidae, Dysdercus cingulatus, Dysdercus intermedius, Eurygaster integriceps, Euschistus impictiventris, Leptoglossus phyllopus, Lygus lineolaris, Lygus pratensis, Nephotettix spp., Nezara vindula, Pentatomidae, Piesma quadrata, Solubea insularis and Thyanta perditor,

Aphids and other Homoptera, e.g. Acyrthosiphon onobrychis, Adelges laricis, Aphidula nasturtii, Aphis fabae, Aphis forbesi, Aphis glycines, Aphis gossypii, Aphis grossulariae, Aphis pomi, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophum dirhodum, Myzodes (Myzus) persicae, Myzus ascalonicus, Myzus cerasi, Myzus varians, Nasonovia ribis-nigri, Nilaparvata lugens, Pemphigus bursarius, Pemphigus populivenae, and other Pemphigus spp., Perkinsiella saccharicida, Phorodon humuli, Psyllidae, e.g. Psylla mali, Psylla piri and other Psylla spp., Rhopalomyzus ascalonicus, Rhopalosiphum maids, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, and Viteus vitifolii;

Lepidoptera, for example Agrotis ypsilon, Agrotis segetum and other Agrotis spp., Alabama argillacea, Anticarsia gemmatalis, Argyresthia conjugella, Autographs gamma, Bupalus piniarius, Cacoecia murinana, Capua reticulana, Chematobia brumata, Chilo suppresalis and other Chilo spp., Choristoneura fumiferana, Choristoneura occidentalis, Cirphis unipuncta, Cnaphlocrods medinalis, Cydia pomonella, Dendrolimus pini, Diaphania nitidalis, Diatraea grandiosella, Earias insulana, Elasmopalpus lignosellus, Eupoecilia ambiguella, Euxoa spp., Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Lerodea eufala, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Momphidae, Orgyia pseudotsugata, Ostrinia nubilalis, Panolis flammea, Pectinophora gossypiella, Perdroma saucia, Phalera bucephala, Phthorimaea operculella, Phyllocnistis citrella, Pier/s brassicae, Plathypena scabra, Plutella xylostella, Pseudoplusia includens, Rhyacionia frustrana, Scrobipalpula absoluta, Sesamia nonagrioides and other Sesamia spp., Sllotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,

Orthoptera, e.g. Acrididae, Acheta domestica, Blatta orientalis, Blattella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus,

Termites (Isoptera), e.g. Calotermes Coptotermes spp., Dalbulus maidis, Leucotermes flavipes, Macrotermes gilvus, Reticulitermes lucifugus and Termes natalensis;

Thrips (Thysanoptera), e.g. Frankliniella fusca, Frankliniella occidentalis, Frankliniella tritici and other Frankliniella spp., Scirtothrips cltri, Thrips oryzae, Thrips palmi, Thrips simplex and Thrips tabaci,

Arachnids, e.g. Arachnida (Acarina), for example, e.g., of the families Argasidae, Ixodidae and Sarcoptidae, e.g. Amblyomma americanum, Amblyomma variegatum, Argas persicus, Boophilus annulatus, Boophilus decoloratus, Boophllus microplus, Dermacentor silvarum, Hyalomma truncatum, Ixodes ricinus, Ixodes rubicundus, Ornithodorus moubata, Otobius megnini, Dermanyssus gallinae, Psoroptes ovis, Rhipicephalus appendiculatus, Rhipicephalus evertsi, Sarcoptes scabiei, and Eriophyidae spp., e.g. Aculus schlechtendan, Phyllocoptrata oleivora and Eriophyes sheldoni, Tarsonemidae spp., e.g. Phytonemus pallidus and Polyphagotarsonemus latus, Tenuipalpidae spp., e.g. Brevipalpus phoenicis; Tetranychidae spp., e.g. Tetranychus cinnabarinus, Tetranychus kanzawai, Tetranychus pacificus, Tetranychus telarius and Tetranychus urticae, Panonychus ulmi, Panonychus citri, and Oligonychus pratensis;

Nematodes, in particular phytoparasitic nematodes, e.g. root knot nematodes, Meloidogyne hapla, Meloidogyne incognita, Meloidogyne javanica, and other Meloidogyne spp.; cyst-forming nematodes, Globodera rostochiensis and other Globodera spp.; Heterodera avenae, Heterodera glycines, Heterodera schachtii, Heterodera trifolii, and other Heterodera spp.; seed gall nematodes, Anguina spp.; stem and foliar nematodes, Aphelenchoides spp.; sting nematodes, Belonolaimus longicaudatus and other Belonolaimus spp.; pine nematodes, Bursaphelenchus xylophilus and other Bursaphelenchus spp.; ring nematodes, Criconema spp., Criconemella spp., Criconemoides spp., Mesocriconema spp.; stem and bulb nematodes, Ditylenchus destructor, Ditylenchus dipsaci and other Ditylenchus spp.; awl nematodes, Dolichodorus spp.; spiral nematodes, Heliocotylenchus multicinctus and other Helicotylenchus spp.; sheath and sheathoid nematodes, Hemicycliophora spp. and Hemicriconemoides spp.; Hirshmanniella spp.; lance nematodes, Hoploaimus spp.; false root knot nematodes, Nacobbus spp.; needle nematodes, Longidorus elongatus and other Longidorus spp.; lesion nematodes, Pratylenchus neglectus, Pratylenchus penetrans, Pratylenchus curvitatus, Pratylenchus goodeyi and other Pratylenchus spp.; burrowing nematodes, Radopholus similis and other Radopholus spp.; reniform nematodes, Rotylenchus robustus and other Rotylenchus spp.; Scutellonema spp.; stubby root nematodes, Trichodorus primitivus and other Trichodorus spp., Paratrichodorus spp.; stunt nematodes, Tylenchorhynchus claytoni, Tylenchorhynchus dubius and other Tylenchorhynchus spp.; citrus nematodes, Tylenchulus spp.; dagger nematodes, Xiphinema spp.; and other phytoparasitic nematodes.

Combating undesirable plant growth means the combating/destruction of plants which grow in places where they are undesirable, e.g. of dicotyledonous plants of the types: Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum.

monocotyledonous plants of the types: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristyslis, Sagittaria, Eleocharis, Scirpus, Paspalum, Ischaemum, Sphenoclea, Dactyloctenium, Agrostis, Alopecurus, Apera.

### EXAMPLES

### Example 1

### Synthesis of Molecularly Imprinted Polymers with Pesticides as Template Molecules

### Example a)

a 2-liter HWS reactor was provided with a reflux condenser, a stirrer motor, an anchor stirrer, a nitrogen inlet pipe with a sintered glass disk, a Julabo LC 3 laboratory control unit with 2 Pt100 temperature sensors, an oil bath with an immersion heater and magnetic stirrer, and also 2 HPLC pumps (Bischoff) with a pump head each (0-1 ml/min) for metering in initiator and monomers. The apparatus was flushed with nitrogen before beginning the test. Nitrogen was passed through the solution at a volumetric flow rate of ca. 10 l/h during the whole of the test. 800 ml of acetonitrile (AcN) solvent were introduced into the reaction vessel and 17.51 g of fipronil (template) were dissolved in this.

An additional solution (solution 1) of 6.12 g of methacrylic acid (functional monomer) and 73.51 g of trimethylolpropane trimethacrylate (crosslinking agent) in 250 ml of acetonitrile was prepared. 1 ml was withdrawn from solution 1 for the later HPLC analysis. One half of the remaining solution 1 was added to the initial charge in the reactor and mixed with this with stirring (100 min⁻¹). Subsequently, a sample of 1 ml was withdrawn from the reactor for the HPLC analysis.

A quarter of the amount of initiator, i.e. 0.532 g, was added to the reactor and, after the accelerated dissolution of the initiator by vigorous stirring, a sample of 1 ml was withdrawn for the later HPLC analysis.

The initial charge in the reactor was heated to 75° C. with stirring and a 1 ml sample was again taken.

An additional solution (solution 2) was prepared, through dissolution, actually, of the remaining ¾ of the initiator, accordingly 1.594 g, in 250 ml of acetonitrile.

The second half of solution 1 and solution 2 were metered into the reactor over a period of 18 h using the two HPLC pumps. The metering rates were 0.153 ml/min for solution 1 and 0.232 ml/min for solution 2.

The subsequent postreaction time was 6 hours and the total reaction time accordingly was thus 24 h. After each complete hour, a sample of 1 ml of the reaction mixture was withdrawn and, after filtration, subjected to HPLC analysis.

### Example b)

a 2-liter HWS reactor was provided with a reflux condenser, a stirrer motor, an anchor stirrer, a nitrogen inlet pipe with a sintered glass disk, a Julabo LC3 laboratory control unit with 2 Pt100 temperature sensors, and an oil bath with an immersion heater and magnetic stirrer. The apparatus was flushed with nitrogen before beginning the test. Nitrogen was passed through the solution at a volumetric flow rate of ca. 10 l/h during the whole of the test. 1000 ml of acetonitrile (AcN) solvent were introduced into the reaction vessel and 18 g of fipronil (template), 6.12 g of methacrylic acid (functional monomer) and 76.32 g of trimethylolpropane trimethacrylate were dissolved in this. The mixture was heated to 65° C. with stirring (100 min⁻¹) and a sample was withdrawn for the HPLC analysis. Finally, 0.564 g of 2,2′-azobis(2-methylbutyronitrile) (initiator) was dissolved in 5 ml of acetonitrile. This solution was slowly injected into the reactor contents. A sample of 10 ml of the reaction mixture was withdrawn after each complete hour and, after filtration, subjected to HPLC analysis. The total reaction time was 5 hours.

### Example 2

### Extraction of the Template from the Polymer

A)

A 500 ml round-bottomed flask was equipped with a Soxhlet apparatus, a reflux condenser, a magnetic stirrer and a laboratory control unit (Julabo LC 3 with 2 Pt100) and immersed in an oil bath. 8 g of polymer (prepared according to example 1a) were extracted in the Soxhlet apparatus with 400 ml of methanol/glacial acetic acid (7:1, v/v) for 6-8 hours (extract 1) and afterwards with 400 ml of methanol for 6 hours (extract 2). The extracts were collected, the volumes thereof were determined and each time a 2 ml sample was stored in a refrigerator at 4° C. for the determination by HPLC of the fipronil concentration.

B)

The mixture obtained from example 1a) was filtered and the residue remaining in the filter was subsequently washed with 100 ml of acetonitrile and then with 100 ml of methanol over a period of 10 min.

### Example 3

### Charging of the Polymer with a Pesticide

After drying the polymer resulting from the Soxhlet extraction, 1 g of polymer from example 2B was mixed with 10 ml of a 0.14 mol/l fipronil solution (preparation of the 0.14 mol/l fipronil solution: 3.3 g of technical grade fipronil (91%) are dissolved in 50 ml of acetonitrile). After an action time of 3 hours, the liquid was separated from the polymer by centrifuging (15 minutes at 3800 rev/min) and decanting. The polymer was dried at 50° C. under vacuum.

### Example 4

### Controlled Release of Pesticides from Molecularly Imprinted Polymers

A) Measurement of the Controlled Release

A Millipore ultrafiltration cell (Model 8400) was connected to a 5-liter plastic container as storage vessel (contents: water). The cell was filled with a dispersion of 100 mg of polymer in 100 ml of water and stirred for 15 minutes until homogeneous with the magnetic stirrer incorporated in the ultrafiltration cell. The extraction medium (water) was conveyed from the storage vessel into the cell via the inlet without excess pressure. The extract flowing out of the cell was conveyed on the underside of the cell into a collecting vessel. Finally, the volume, the weight and the time of the individual fractions were determined and a sample of 2 ml was withdrawn from each fraction. Several fractions were collected over the test period. These samples were filtered through a 0.45 μl filter and stored in a refrigerator at 4° C. for the determination by HPLC of the fipronil concentration. After the end of the test, the dispersion was withdrawn from the ultrafiltration vessel and sealed in containers.

B) Comparison of a Charged Molecularly Imprinted Polymer with a Charged Polymer Which is not Molecularly Imprinted

The release behavior of a molecularly imprinted polymer (MIP1, prepared according to example 3) charged after the polymerization was with the release rate of a non-imprinted control polymer (CP1) charged after the polymerization, the data being ascertained according to the instructions cited in example 4A). CP1 was synthesized analogously to the preparation instructions disclosed in example 1a, but in the absence of the active agent fipronil. The washing of the polymer obtained was carried out with each 100 ml of acetonitrile and methanol analogously to example 2B and the subsequent charging with active agent was carried out analogously as in example 3.

The results are represented in FIG. 1 (MIP1, upper curve, black squares; CP1, lower curve, gray diamonds). The amount of fipronil released is given in mg. They show that the release rates of the molecularly imprinted polymer are better in comparison with the polymer which has not been molecularly imprinted.

C) Comparison of a Charged Molecularly Imprinted Polymer with a Molecularly Imprinted Polymer which has not been Charged

The release behavior of a molecularly imprinted polymer charged after the polymerization (MIP2 according to example 3) and of a molecularly imprinted polymer not subsequently charged after the polymerization according to example 2B (MIP2, not charged) were compared, the data being ascertained according to the instructions cited in example 4A).

The results are represented in FIG. 2 (MIP2, charged, upper curve, black squares); (MIP2, not charged, low curve, light triangles). The amount of fipronil released is given in mg.

They show that the good release rates by subsequent charging are achievable.

1-8. (canceled)

9. A formulation with controlled release of active agent comprising an acrylate polymer molecularly imprinted in the presence of at least one pesticide, which polymer is composed of at least one functional monomer and at least one crosslinking agent, and at least one pesticide, said formulation prepared via a process which comprises
(1) preparing acrylate polymer particles through precipitation polymerization in the presence of the pesticide;
(2) subsequently washing the particles;
(3) incubating the particles with a solution of the pesticide; and
(4) crosslinking the particles using crosslinking agents of threefold or higher functionality.

10. The formulation of claim 9, wherein the precipitation polymerization in stage (1) comprises:
(a) mixing at least one functional monomer with at least one pesticide in a suitable solvent, adding at least one crosslinking agent and starting the polymerization; or
(b) mixing at least one functional monomer with at least one pesticide and a crosslinking agent in a suitable solvent, followed by starting the polymerization.

11. The formulation of claim 9, wherein the ratio by weight of polymer to pesticide is 1:1 to 10:1.

12. The formulation of claim 9, wherein the acrylate polymer is synthesized from
(a) at least one functional monomer selected from the group consisting of hydroxyalkyl(meth)acrylates, (meth)acrylamides, alkyl(meth)acrylates, cyano(alky)acrylates, acrylic acid and methacrylic acid,
(b) at least one crosslinking agent selected from the group consisting of ethylenically unsaturated compounds with at least two vinyl or allylic double bonds which can be polymerized under free radical conditions.

13. The formulation of claim 9, wherein the molar ratio of functional monomer to crosslinking agent is 1:2 to 1:10.

14. A method for regulating the growth of plants or for combating phytopathogenic fungi, undesirable plant growth, or undesirable insect or acarid infestation, wherein the formulation of claim 9 is allowed to act
(a) on the phytopathogenic fungi or the undesirable plant, insect or acarid, or their habitat or
(b) on the plants or soil to be protected from the phytopathogenic fungi or the undesirable plant, insect, or acarid, or their habitat.

15. A method for combating undesirable insect or acarid infestation on plants, for combating phytopathogenic fungi, or for combating undesirable plant growth, wherein seeds of useful plants are treated with the formulation of claim 9.

16. A seed, treated with a formulation comprising an acrylate polymer molecularly imprinted in the presence of a pesticide and also at least one pesticide.
